(19) United States
(12) Patent Application Publication
(10) Pub. No.: US 2007/0245847 A1
(43) Pub. Date: Oct. 25, 2007

(54) Shift control device for bicycle

(75) Inventor: Chien-Yuan Chen, Taichung Hsien (TW)

Correspondence Address: BACON & THOMAS, PLLC, 625 SLATERS LANE, FOURTH FLOOR, ALEXANDRIA, VA, 22314, US

(73) Assignee: AD-II ENGINEERING INC., TAICHUNG HSIEN (TW)

(21) Appl. No.: 11/709,713

(22) Filed: Feb. 23, 2007

(30) Foreign Application Priority Data
Apr. 25, 2006 (TW) 95207038

(51) Int. Cl. F16C 1/10

(52) U.S. Cl. 74/502.2

(57) ABSTRACT

A shift control device includes a mount, a derailleur cable control unit, which is auto-reversibly pivotally mounted on the mount for the mounting of a derailleur cable and has a first sector gear portion, a second sector gear portion, and a one-way rotary driven portion, a first shifter, which is auto-reversibly pivotally mounted on the mount and has a one-way rotary driving portion for driving the one-way rotary driven portion to rotate the derailleur cable control unit in one direction, and a second shifter, which is auto-reversibly pivotally mounted on the mount and has a first tooth and a second tooth for meshing with the first sector gear portion and the second sector gear portion to control return action of the derailleur cable control unit when the second shifter is biased relative to the mount, the first tooth and the second tooth being moved over the sloping teeth of the first sector gear portion and the sloping teeth of the second sector gear portion tooth by tooth respectively when the first shifter is operated to rotate the derailleur cable control unit.

### BACKGROUND OF THE INVENTION

1. Field of the Invention

The present invention relates to bicycles and more specifically, to a shift control device for bicycle.

2. Description of the Related Art

The shifters of a bicycle for control gear shifting of the rear derailleur and the handlebars of the bicycle are separately provided. The separated design of the shifters greatly increases the manufacturing cost of the bicycle. There are bicycles that have the shift control device joined to the brake lever of the brake system, thereby saving the manufacturing cost.

However, because the shifting gear of the aforesaid prior art shift control device is not precisely fitted, gear shifting may be not accurately achieved when operating the lever to shift to the next gearshift position, and the gear may jump to the first gearshift position erroneously when reversing the engagement position of the gear.

### SUMMARY OF THE INVENTION

The present invention has been accomplished under the circumstances in view. It is one object of the present invention to provide a shift control device, which has the component parts thereof accurately matched and, which can be independently installed in a bicycle or incorporated with the brake lever of the brake system of a bicycle. It is another object of the present invention to provide a shift control device, which has the first sector gear portion and second sector gear portion of the derailleur cable control unit thereof be abutted together, simplifying the structure of the derailleur cable control unit for easy installation and accurate gearshift position control. It is still another object of the present invention to provide a shift control device, which allows accurate forward/reverse rotation control of the derailleur cable control unit, preventing a gear disengagement error.

To achieve these and other objects of the present invention, the shift control device comprises a mount, the mount comprising a body, first pivot means and second pivot means respectively formed in the body of the mount; a derailleur cable control unit for the mounting of a derailleur cable, the derailleur cable control unit being pivotally mounted on the first pivot means of the mount and reversible by spring means, the derailleur cable control unit comprising a first sector gear portion formed of a series of sloping teeth, a second sector gear portion formed of a series of sloping teeth and connected to the first sector gear portion, and a one-way rotary driven portion; a first shifter pivotally coupled to the first pivot means of the mount and reversible by spring means, the first shifter comprising a one-way rotary driving portion corresponding to the one-way rotary driven portion of the derailleur cable control unit for driving the derailleur cable control unit to rotate in one direction; and a second shifter pivotally coupled to the second pivot means of the mount and reversible by spring means, the second shifter comprising a first tooth and a second tooth for meshing with the first sector gear portion and the second sector gear portion of the derailleur cable control unit to control return action of the derailleur cable control unit when the second shifter is biased relative to the mount, the first tooth and the second tooth being moved over the sloping teeth of the first sector gear portion and the sloping teeth of the second sector gear portion tooth by tooth respectively when the first shifter is operated to rotate the derailleur cable control unit.

### BRIEF DESCRIPTION OF THE DRAWINGS

FIG. 1 is an exploded view of a shift control device in accordance with the present invention.

FIG. 2 corresponds to FIG. 1 when viewed from another angle.

FIG. 3 is a further exploded view in an enlarged scale of a part of FIG. 1.

FIG. 4 is an exploded view of the derailleur cable control unit of the shift control device according to the present invention.

FIG. 5A is an assembly plain view of the first shifter, the second shifter and the derailleur cable control unit.

FIG. 5B is another assembly plain view of the first shifter, the second shifter and the derailleur cable control unit when viewed from another angle.

FIG. 6A corresponds to FIG. 5A, showing the proceeding of the gearshift position changing action.

FIG. 6B corresponds to FIG 5B, showing the proceeding of the gearshift position changing action.

FIG. 7A corresponds to FIG. 6A, showing the gearshift position changing action finished.

FIG. 7B corresponds to FIG. 6B, showing the gearshift position changing action finished.

FIG. 8 is an assembly plain view of the second shifter and the derailleur cable control unit, showing the proceeding of the reverse shifting action.

FIG. 9 corresponds to FIG. 8, showing the reverse shifting action finished.

### DETAILED DESCRIPTION OF THE INVENTION

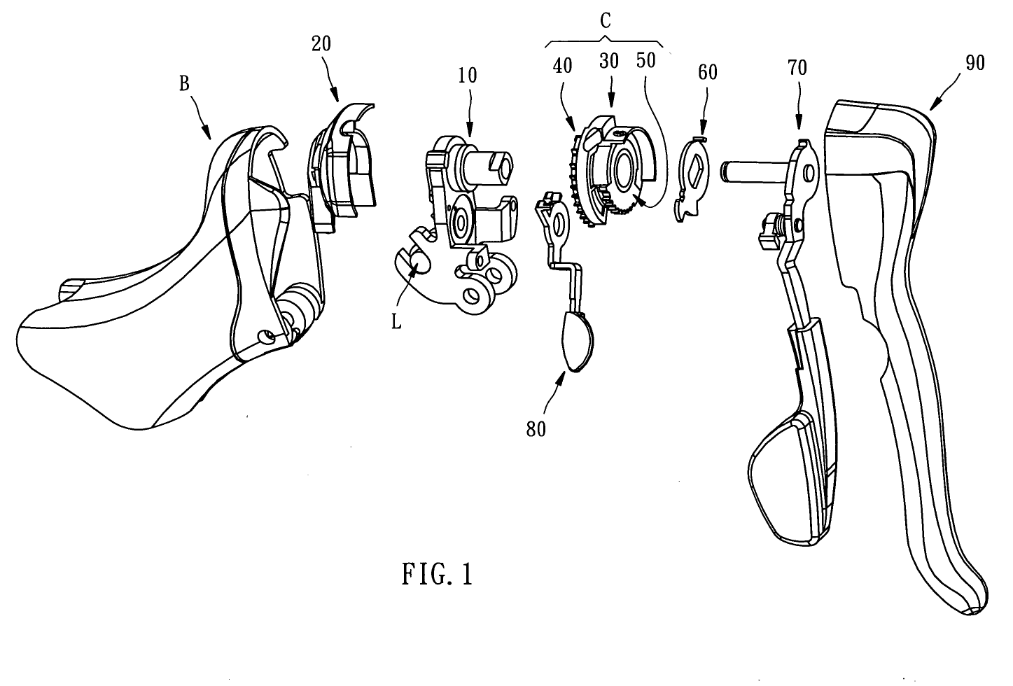

Referring to FIG. 1, a shift control device in accordance with the present invention is shown installed in a holder block B at a bicycle's handlebar (not shown) for pulling a derailleur cable (not shown). The shift control device further has a brake cable rod L installed therein. The brake cable rod L has a cable hole L1 for the connection of a brake cable (not shown).

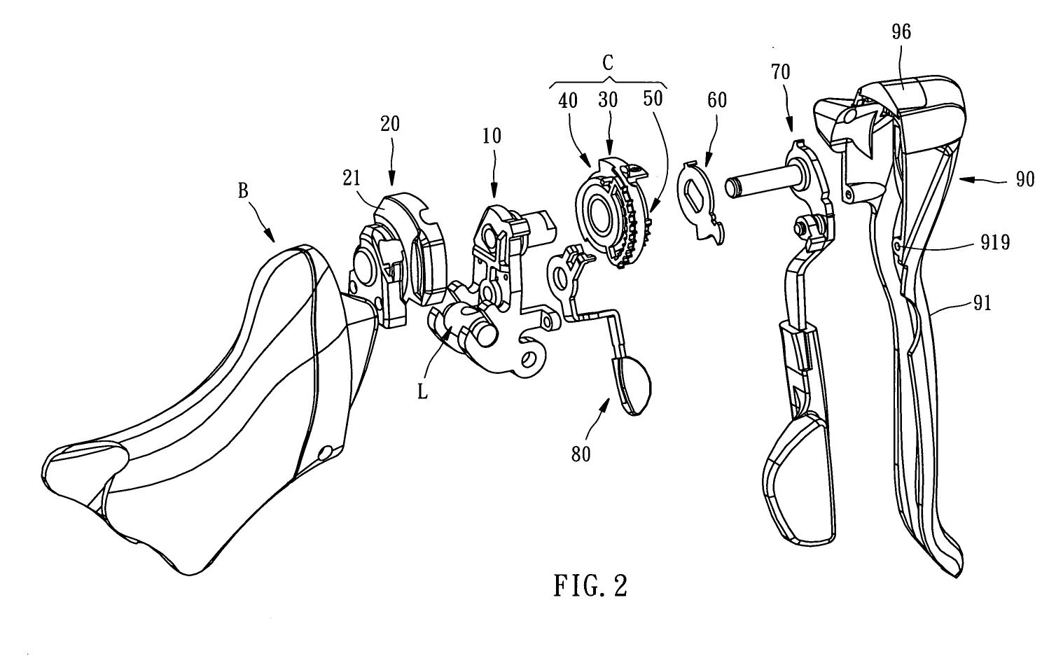

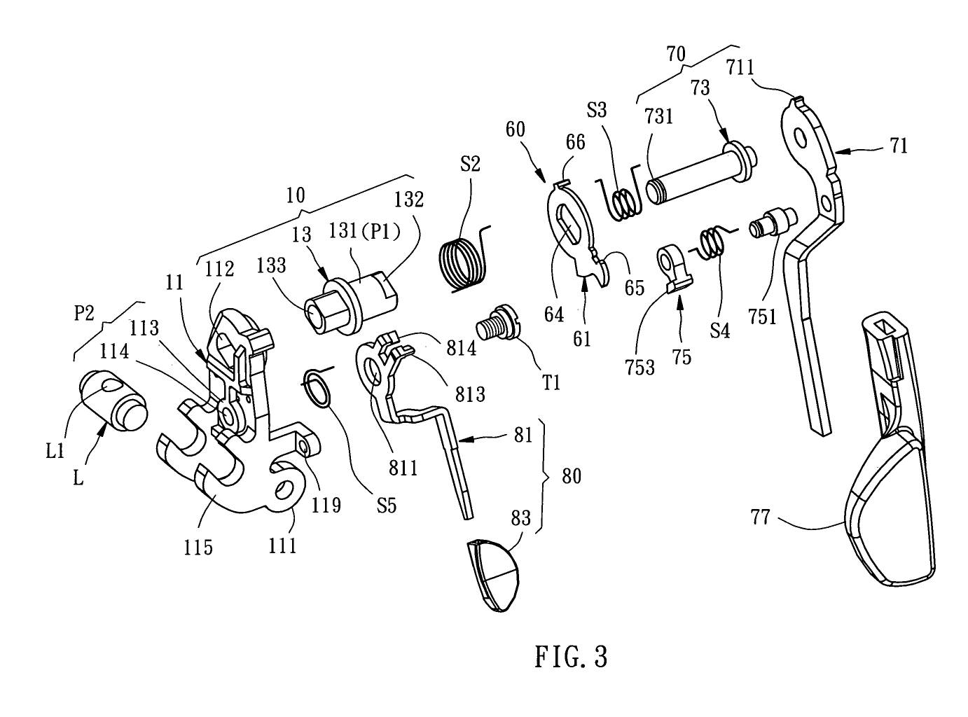

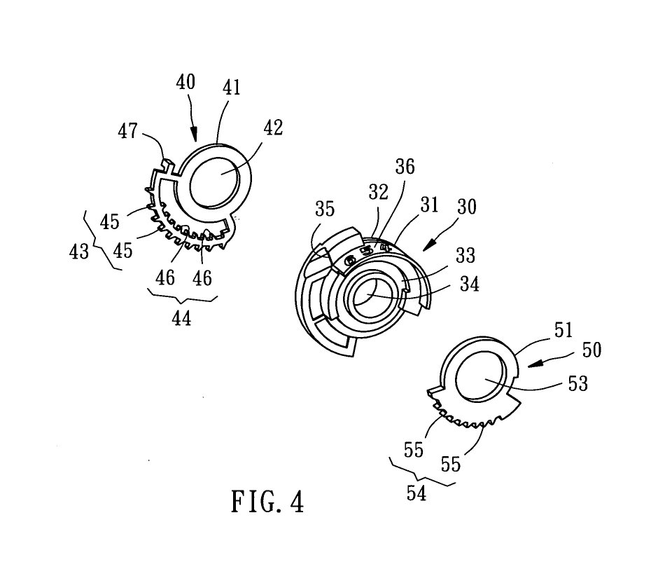

Referring to FIGS. 2˜4 and FIG. 1 again, the shift control device comprises a mount 10, a protect cover 20, a cable wheel 30, a gear member 40, a one-way rotary driven member 50, a limiter 60, a first shifter 70, a second shifter 80, and a brake lever 90.

The mount 10 comprises a body 11 and a connection rod 13. The body 11 has a coupling portion 111 pivotally coupled to the holder block B, a mounting hole 112, a bearing portion 113, a pivot hole 114 cut through the bearing portion 113, a pivot support 115 provided at the rear bottom side thereof for supporting the brake cable rod L, and two screw holes 119 at suitable locations. Further, a return spring (not shown) is provided between the body 11 and the holder block B for returning the body 11 after each biasing action of the body 11 relative to the holder block B. The connection rod 13 is fastened to the mounting hole 112 of the body 11, having a shaft body 131, a stepped portion 132 at one end of the shaft body 131, and an axle hole 133 axially cut through the two distal ends of the shaft body 131. The shaft body 131 and the axle hole 133 constitute first pivot means P1. The bearing portion 113 and the pivot hole 114 constitute second pivot means P2.

The protect cover 20 has a cover body 21 provided between the holder block B and the mount 10 and surrounding the mount 10.

The cable wheel 30 has a wheel body 31, a first receiving portion 32 and a second receiving portion 33 respectively provided at the top and bottom sides of the wheel body 31, a pivot hole 34 disposed at the center of the wheel body 31 and coupled to the shaft body 131 of the connection rod 13 of the mount 10, a derailleur cable hole 35 provided at the periphery of the wheel body 31 for the mounting of the derailleur cable, a gearshift position indicator means, for example, a series of Arabic numerals 36 marked on the periphery of the wheel body 31 for indicating the current gearshift position.

The gear member 40 has a circular flat frame 41, a pivot hole 42 cut through the flat frame 41 and coupled to the first receiving portion 32 of the cable wheel 30, a first sector gear portion 43 and a second sector gear portion 44 abutted together at the periphery of the flat frame 41, and a pin 47 provided between the circular flat frame 41 and the first sector gear portion 43. The first sector gear portion 43 is comprised of a series of sloping teeth 45. The second sector gear portion 44 is comprised of a series of sloping teeth 46.

The one-way rotary driven member 50 has a circular flat frame 51, a pivot hole 52 cut through the flat frame 51 and coupled to the second receiving portion 33 of the cable wheel 30, and a one-way rotary driven portion 54. According to this embodiment, the one-way rotary driven portion 54 is a sector gear formed of a series of sloping teeth 55.

The aforesaid cable wheel 30, gear member 40 and one-way rotary driven member 50 constitute a derailleur cable control unit C for a linking action. Further, a return spring S2 is set in between the body 11 of the mount 10 and the pin 47 of the gear member 40 to impart a reversing force.

The limiter 60 has a flat base 61, an oblong mounting hole 64 affixed to the stepped portion 132 of the connection rod 13 of the mount 10, a first stop portion 65, and a second stop portion 66. The first stop portion 65 and the second stop portion 66 are respectively protruded from the periphery of the flat base 61 at suitable locations.

The first shifter 70 comprises a lever 71, which has a protruding stop portion 711 disposed at one end, a return spring S3 coupled between the stop portion 711 of the lever 71 and the second stop portion 66 of the limiter 60, an axle 73 connected to one end of the lever 71 adjacent to the protruding stop portion 711 and inserted through the axle hole 133 of the connection rod 13 of the mount 10, a retaining ring 731 fastened to one end of the axle 73 remote from the lever 71 to secure the axle 73 to the connection rod 13 of the mount 10, a one-way rotary driving member 75 coupled to the lever 71 with a pin 751, a return spring S4 mounted on the pin 751 and coupled between the pin 751 and the rotary driving member 75 for returning the rotary driving member 75 each time the rotary driving member 75 has been biased relative to the lever 71 and then released, and a handle 77 for operation by finger to bias the first shifter 70 relative to the connection rod 13 of the mount 10. The one-way rotary driving member 75 has a one-way rotary driving portion 753 for driving the one-way rotary driven portion 54 of the one-way rotary driven member 50.

The second shifter 80 comprises a lever 81 and a handle 83. The lever 81 has a pivot hole 811 formed in one end thereof and pivotally coupled to the second pivot means P2 of the mount 10 with a screw bolt T1 for idle rotation relative to the mount 10, a first tooth 813 for engagement with the first sector gear portion 43 of the gear member 40, and a second tooth 814 for engagement with the second sector gear portion 44 of the gear member 40. Further, a return spring S5 is coupled between the lever 81 and the mount 10 and adapted to return the lever 81 each time the lever 81 has been biased and released. The handle 83 is fastened to the lever 81 for operation by finger to bias the second shifter 80 relative to the screw bolt T1.

The brake lever 90 has a lever body 91, two screw holes 919 formed in the lever body 91 and respectively fastened to the screw holes 119 of the mount 10 with a respective screw (not shown), and gearshift position indicator means, for example, a display window with an index 96 formed on the lever body 91 for indicating one of the Arabic numerals 36 of the gearshift position indicator means to indicate the current gearshift position.

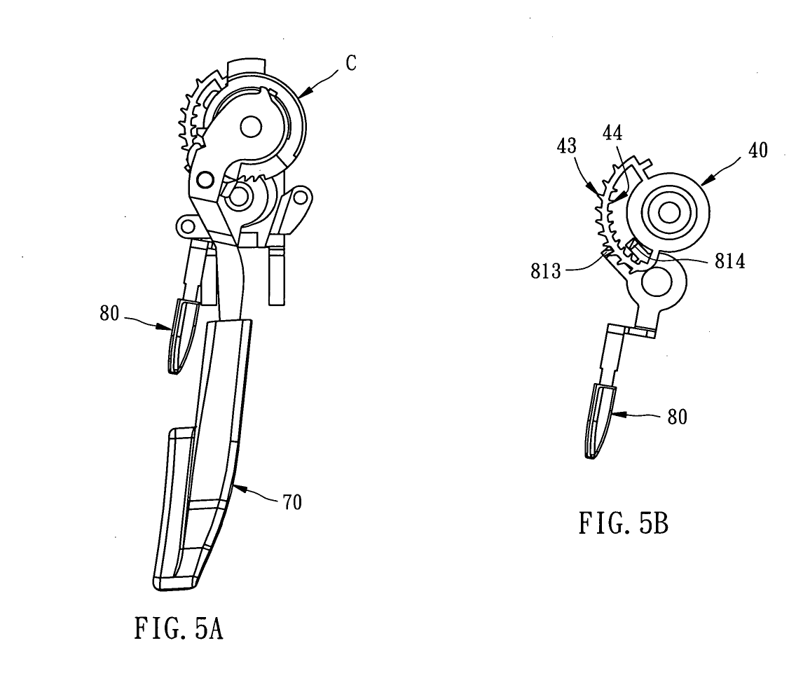

The operation of the present invention is outlined hereinafter with reference to FIGS. 5˜9.

As shown in FIGS. 5A and 5B, when the first shifter 70 and the second shifter 80 are not operated, the first tooth 813 of the second shifter 80 is meshed with the first sector gear portion 43 of the gear member 40.

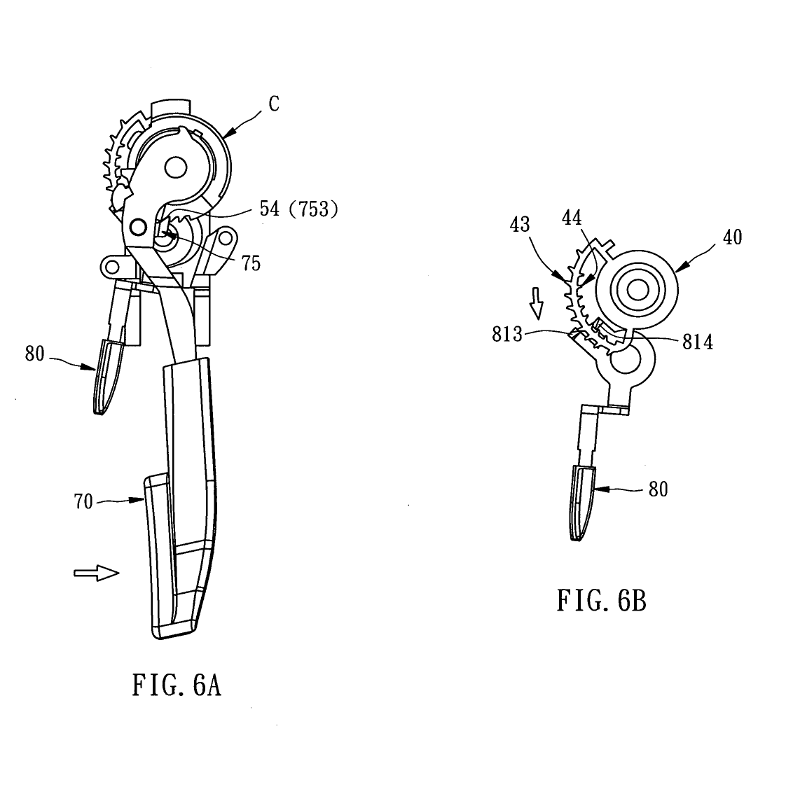

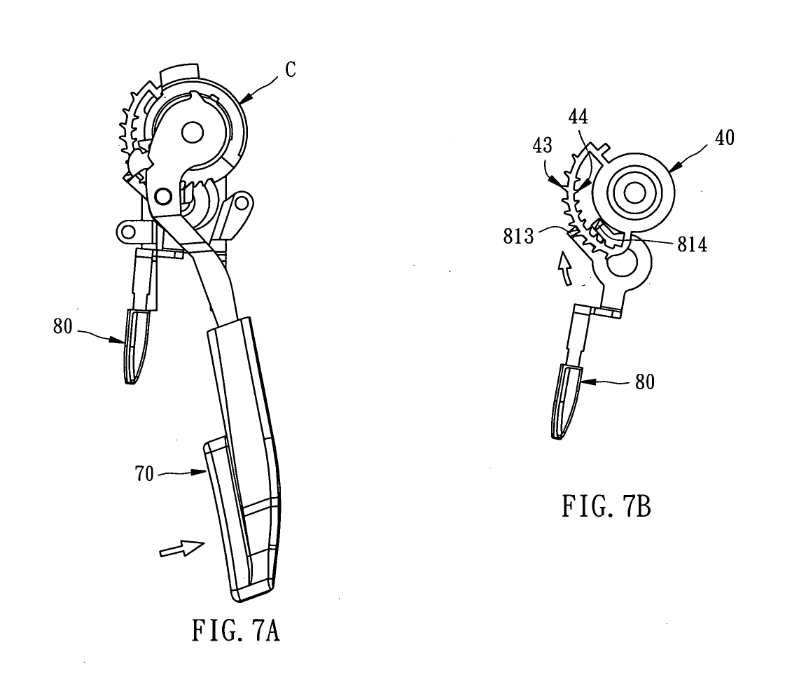

When operating the forefinger to bias the first shifter 70 as shown in FIG. 6A, the one-way rotary driving portion 753 of the one-way rotary driving member 75 of the first shifter 70 is forced against the one-way rotary driven portion 54 of the one-way rotary driven member 50, causing rotation of the derailleur cable control unit C. At the same time, as shown in FIG. 6B, the first tooth 813 and second tooth 814 of the second shifter 80 are respectively moved over the sloping teeth 45 of the first sector gear portion 43 and the sloping teeth 46 of the second sector gear portion 44 tooth by tooth. When continuously biasing the first shifter 70 as shown in FIGS. 7A and 7B, the first tooth 813 and second tooth 814 of the lever 81 of the second shifter 80 are moved, and finally achieving the desired gearshift operation.

When released the first shifter 70 from the finger, the first shifter 70 is automatically returned. At this time, the one-way rotary driving member 75 of the first shifter 70 is stopped against the first stop portion 65 of the limiter 60, therefore the first shifter 70 does not engage the one-way rotary driven member 50 of the derailleur cable control unit C.

At this time, the user can bias the first shifter 70 again to forwardly shift the gearshift position in the same manner as stated above with the exception that the position of the one-way rotary driven member 50 of the derailleur cable control unit C has been changed.

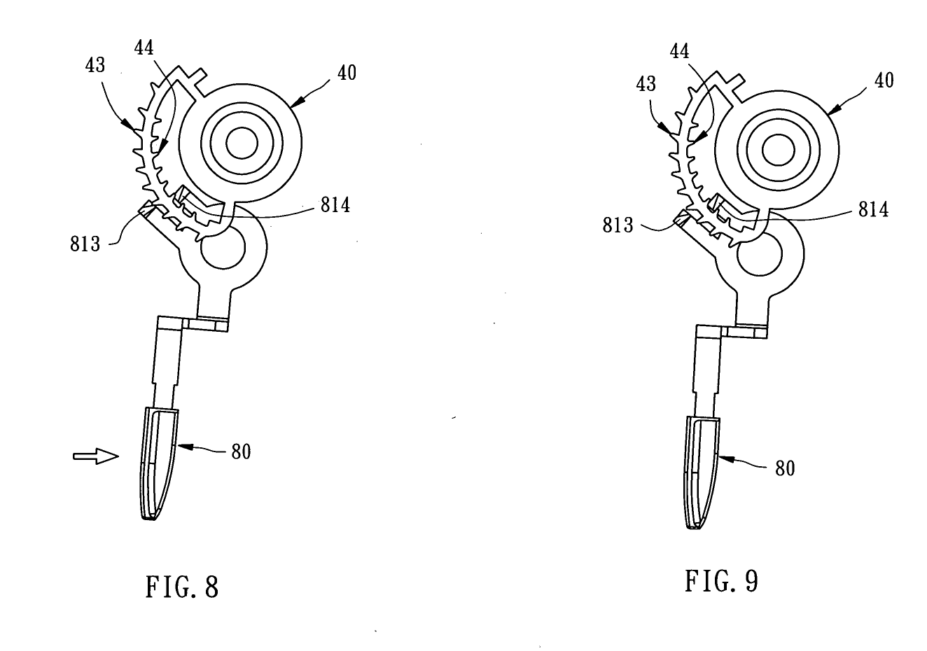

When reversing the gearshift position as shown in FIG. 8, bias the second shifter 80 to move the first tooth 813 and the second tooth 814 over the sloping teeth 45 of the first sector gear portion 43 and the sloping teeth 46 of the second sector gear portion 44 respectively, as shown in FIG. 9, and then release the second shifter 80 for enabling the derailleur cable control unit C to be retuned by the pulling force of the derailleur cable step by step.

According to this embodiment, the first tooth 813 and the second tooth 814 are spaced corresponding to one half of the pitch of the gearshift positions to match the sloping teeth 45 of the first sector gear portion 43 and the sloping teeth 46 of the second sector gear portion 44 accurately, preventing a disengagement error.

Although a particular embodiment of the invention has been described in detail for purposes of illustration, various modifications and enhancements may be made without departing from the spirit and scope of the invention. For example, the invention can be made subject to the following alternations.

The first sector gear portion and second sector gear portion of the derailleur cable control unit can be arranged at different elevations instead of the aforesaid parallel design. In this case, the first tooth and second tooth of the second shifter shall also be arranged at difference elevations.

The first sector gear portion and the second sector gear portion of the derailleur cable control unit can be set apart and respectively extending in different directions.

Either two or all the three members of the cable wheel, gear member and one-way rotary driven member of the derailleur cable control unit can be made in integrity, saving much material and simplifying the fabrication.

The one-way rotary driven portion of the derailleur cable control unit and the one-way rotary driving portion of the first shifter can be formed with balls or needle rollers, forming a one-way axle bearing.

Further, the display window with index can be provided at the cable wheel and the series of Arabic number can be marked on the lever body of the brake lever for indicating the current gearshift position.

As indicated above, the shift control device of the present invention has the following benefits:

1. The component parts of the shift control device of the present invention are simple and accurately matched. The shift control device can be independently installed in the bicycle. Alternatively, the shift control device can be incorporated with the brake system of the bicycle.

2. The first sector gear portion and second sector gear portion of the derailleur cable control unit are abutted together, simplifying the structure of the derailleur cable control unit for easy installation and accurate gearshift position control.

3. By means of the stated parts to control forward and reverse rotation of the derailleur cable control unit, the first shifter and the second shifter enable the derailleur cable control unit to be accurately operated, preventing a gear disengagement error.

What is claimed is:

1. A shift control device comprising:
a mount, said mount comprising a body, first pivot means and second pivot means respectively formed in the body of said mount;
a derailleur cable control unit for the mounting of a derailleur cable, said derailleur cable control unit being pivotally mounted on said first pivot means of said mount and reversible by spring means, said derailleur cable control unit comprising a first sector gear portion formed of a series of sloping teeth, a second sector gear portion formed of a series of sloping teeth and connected to said first sector gear portion, and a one-way rotary driven portion;
a first shifter pivotally coupled to said first pivot means of said mount and reversible by spring means, said first shifter comprising a one-way rotary driving portion corresponding to said one-way rotary driven portion of said derailleur cable control unit for driving said derailleur cable control unit to rotate in one direction; and
a second shifter pivotally coupled to said second pivot means of said mount and reversible by spring means, said second shifter comprising a first tooth and a second tooth for meshing with said first sector gear portion and said second sector gear portion of said derailleur cable control unit to control return action of said derailleur cable control unit when said second shifter is biased relative to said mount, said first tooth and said second tooth being moved over the sloping teeth of said first sector gear portion and the sloping teeth of said second sector gear portion tooth by tooth respectively when said first shifter is operated to rotate said derailleur cable control unit.

2. The shift control device as claimed in claim 1, wherein said first sector gear portion and said second sector gear portion are abutted against each other side by side.

3. The shift control device as claimed in claim 1, wherein said first sector gear portion and said second sector gear portion are arranged at difference elevations.

4. The shift control device as claimed in claim 1, wherein said derailleur cable control unit comprises a cable wheel and a gear member fastened to said cable wheel, said gear member having a part configuring said first sector gear portion and said second sector gear portion.

5. The shift control device as claimed in claim 1, wherein said derailleur cable control unit comprises a cable wheel and a one-way rotary driven member fastened to said cable wheel, said one-way rotary driven member having a part configuring said one-way rotary driven portion.

6. The shift control device as claimed in claim 1, wherein said first shifter comprises a one-way rotary driving member, said one-way rotary driving member having a part configuring said one-way rotary driving portion.

7. The shift control device as claimed in claim 1, wherein said one-way rotary driven portion of said derailleur cable control unit is a sector gear.

8. The shift control device as claimed in claim 1, further comprising a protect cover surrounding said mount.

9. The shift control device as claimed in claim 1, further comprising a holder block, which supports said mount, and a brake lever pivoted to the body of said mount for biasing said mount relative to said holder block to pull a brake cable.

10. The shift control device as claimed in claim 1, further comprising a brake lever, a gearshift position indicator means provided at said derailleur cable control unit, and a gearshift position indicator means formed on said brake lever for pointing out said gearshift position indicator means to indicate the current gearshift position.

11. A shift control device for driving a brake cable and a derailleur cable, comprising:
a holder block installed in a handlebar of a bicycle;
a mount, said mount comprising a body, first pivot means and second pivot means respectively formed in the body of said mount;
a derailleur cable control unit for the mounting of a derailleur cable, said derailleur cable control unit being pivotally mounted on said first pivot means of said mount and reversible by spring means, said derailleur cable control unit comprising a first sector gear portion formed of a series of sloping teeth, a second sector gear portion formed of a series of sloping teeth, and a one-way rotary driven portion;
a first shifter pivotally coupled to said first pivot means of said mount and reversible by spring means, said first shifter comprising a one-way rotary driving portion for driving said one-way rotary driven portion of said derailleur cable control unit to rotate said derailleur cable control unit when said first shifter is biased by an external force; and
a second shifter pivotally coupled to said second pivot means of said mount and reversible by spring means, said second shifter comprising a first tooth and a second tooth for meshing with said first sector gear portion and said second sector gear portion of said derailleur cable control unit to control return action of said derailleur cable control unit when said second shifter is biased relative to said mount, said first tooth and said second tooth being moved over the sloping teeth of said first sector gear portion and the sloping teeth of said second sector gear portion tooth by tooth respectively when said first shifter is operated to rotate said derailleur cable control unit; and
a brake lever connected to the body of said mount and operation by the user to bias said mount relative to said holder block.

12. The shift control device as claimed in claim 11, wherein said first sector gear portion is connected to said second sector gear portion.

13. The shift control device as claimed in claim 12, wherein said first sector gear portion and said second sector gear portion are abutted against each other side by side.

14. The shift control device as claimed in claim 12, wherein said first sector gear portion and said second sector gear portion are arranged at difference elevations.

15. The shift control device as claimed in claim 11, wherein said first sector gear portion and said second sector gear portion of said derailleur cable control unit are set apart and extending in different directions.

16. The shift control device as claimed in claim 11, wherein said derailleur cable control unit comprises a cable wheel and a gear member fastened to said cable wheel, said gear member having a part configuring said first sector gear portion and said second sector gear portion.

17. The shift control device as claimed in claim 11, wherein said derailleur cable control unit comprises a cable wheel and a one-way rotary driven member fastened to said cable wheel, said one-way rotary driven member having a part configuring said one-way rotary driven portion.

18. The shift control device as claimed in claim 11, wherein said first shifter comprises a one-way rotary driving member, said one-way rotary driving member having a part configuring said one-way rotary driving portion.

19. The shift control device as claimed in claim 11, wherein said one-way rotary driven portion of said derailleur cable control unit is a sector gear.

20. The shift control device as claimed in claim 11, wherein said derailleur cable control unit comprises a gearshift position indicator means, and said brake lever comprises a gearshift position indicator means for pointing out said gearshift position indicator means to indicate the current gearshift position.
